(19) United States
(12) Patent Application Publication
(10) Pub. No.: US 2025/0216033 A1
(43) Pub. Date: Jul. 3, 2025

(54) LOW-PRESSURE STORAGE AND SEPARATION OF BIOGAS IN ADSORBED GAS SYSTEMS IN VEHICLES AND ASSOCIATED METHOD OF USE

(71) Applicant: THE CURATORS OF THE UNIVERSITY OF MISSOURI, Columbia, MO (US)

(72) Inventors: Peter Pfeifer, Columbia, MO (US); Carlos Wexler, Columbia, MO (US); Fateme Rezaei, Columbia, MO (US)

(21) Appl. No.: 19/003,426

(22) Filed: Dec. 27, 2024

Related U.S. Application Data
(60) Provisional application No. 63/616,252, filed on Dec. 29, 2023.

(51) Int. Cl. F17C 5/06; B01D 53/00; B01J 20/20

(52) U.S. Cl. CPC F17C 5/06; B01D 53/00; B01J 20/20; B01D 2253/102; B01D 2253/308; B01D 2257/504; B01D 2257/7025; F17C 2221/033; F17C 2223/035; F17C 2225/033; F17C 2260/05; F17C 2270/0171; F17C 2270/0581

(57) ABSTRACT

A vehicular adsorbed natural gas (ANG) tank system operates as a mobile, dual gas storage/separation system to enable off-the-natural-gas-grid producers of biogas to use, ship, and process biogas for: (a) onboard delivery to engine of on-demand delivery of methane-rich fuel to an internal-combustion engine; (b) onboard separation of methane from carbon dioxide and extraction of unused fuel as carbon-dioxide-rich commodity, and (c) and large-scale, tractor-trailer shipping of biogas to a biogas upgrading plant and separation of methane from carbon dioxide during discharge at the plant. A mobile tank system on a vehicle comprises vessels filled with porous adsorbent and pressure valves; pressure regulators; pressure/temperature transducers at inlet, outlet, intermediate ports; and an onboard compressor/gas extraction pump. The tank discharging procedure for the separation of biogas into methane and carbon dioxide is such that the concentration of methane in discharged gas is at least 10% greater than in biogas.

### CROSS REFERENCE TO RELATED APPLICATIONS

This application claims priority under 35 U.S.C. § 119 to provisional patent application U.S. Ser. No. 63/616,252, filed Dec. 29, 2023. The provisional patent application is hereby incorporated by reference in its entirety herein, including without limitation: the specification, claims, and abstract, as well as any figures, tables, appendices, or drawings thereof.

### STATEMENT REGARDING FEDERALLY SPONSORED RESEARCH OR DEVELOPMENT

This invention was made with government support under 2044726 awarded by the National Science Foundation. The government has certain rights in the invention.

### TECHNICAL FIELD

The present disclosure relates generally to the storage, transport, and delivery of gaseous renewable energy carriers. A prominent source for such carriers is biogas, produced in landfills, sewage treatment plants, and anaerobic digesters at farms. On average, it consists of about 60 vol % methane (CH₄) and 40 vol % carbon dioxide (CO₂), with a fraction of other compounds. There are two pathways how biogas can be utilized as a renewable energy source.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Biogas can be used, essentially as is, to power local heating and power plants or vehicular internal combustion engines, near the biogas production site. However, biogas, on average, has only a calorific value of 60% compared to standard, pipeline-grade natural gas (NG, ˜90 vol % CH₄]. In this scenario, biogas is a low-cost, low-grade form of renewable natural gas (RNG), locally produced and locally utilized, and CO₂, which is potentially a valuable commodity if captured, escapes into the atmosphere.

In the production of high-grade, pipeline-grade RNG, biogas is collected in pipelines (distinct from the NG grid) and pumped to an RNG plant, where it is processed in large-scale clean-up systems in several steps. The most cost-intensive step is the separation of CH₄ from CO₂. However, many agricultural producers of biogas are located in remote areas, not served by any pipelines to an RNG plant. In the absence of pipelines to an RNG plant, biogas producers are looking for other means to ship biogas to an RNG plant.

Thus, there exists a need in the art for low-cost and low-pressure shipping and storage of biogas.

### SUMMARY

The present disclosure is generally related to low-pressure adsorbed natural gas (ANG) storage and delivery systems (often referred to as tanks, vessels, or cylinders). Such tanks typically operate at pressures of 60-70 bar and are used, or are considered for use, as fuel tanks on natural gas vehicles (NGVs), ranging from light-duty to heavy-duty vehicles to tractor-trailer configurations for large-scale transport of natural gas (virtual pipelines). ANG tanks are an alternative to compressed natural gas (CNG) tanks, which operate at high pressures of 200-250 bar. The attractiveness of ANG relative to CNG lies in lower fueling-station infrastructure and operating costs due to low pressure (1-stage compressor instead of 4-stage compressor).

The present disclosure can further provide for a vehicular adsorbed natural gas (ANG) tank system that operates as a dual gas storage/separation system to enable off-the-natural-gas-grid producers of biogas to use, ship, and process biogas (˜60 vol % methane, ˜40 vol % carbon dioxide).

The vehicular ANG tank system can further provide for onboard, on-demand delivery of methane-rich fuel (≥80 vol % methane) to an internal-combustion engine.

The vehicular ANG tank system can further provide for onboard, on-demand separation of methane from carbon dioxide and extraction of unused fuel as carbon-dioxide-rich commodity (>95 vol % carbon dioxide).

The vehicular ANG tank system can further provide for large-scale, tractor-trailer shipping of biogas to a biogas upgrading plant and separation of methane from carbon dioxide upon discharge at the plant.

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide a vehicular adsorbed natural gas (ANG) tank system that operates as a mobile, dual gas storage/separation system. The ANG system utilizes low-pressure storage and separation of biogas in vehicles.

It is still yet a further object, feature, and/or advantage of the present disclosure to control separation of CH₄ and CO₂ by pressure and/or temperature-swing desorption.

It is still yet a further object, feature, and/or advantage of the present disclosure to control separation of CH₄ and CO₂ by expanding the pore/void space (e.g., with a movable piston in the tank).

It is still yet a further object, feature, and/or advantage of the present disclosure to control separation of CH₄ and CO₂ by choosing an adsorbent with a large porosity o.

It is still yet a further object, feature, and/or advantage of the present disclosure to control separation of CH₄ and CO₂ by or by choosing an adsorbent with lower binding energy for CH₄ and CO₂ (larger pore width), we can shift “separation” to “non-separation”.

It is still yet a further object, feature, and/or advantage of the present disclosure to improve upon the process of separating at least one gas species (e.g., methane—CH₄) from a mixture of gases (e.g., air) under pressure according to the at least one species' molecular characteristics and affinity for an adsorbent material. Notably, the improved process includes the capability to store, either on a vehicle or at biogas upgrading facility, at least two gas species (e.g., methane—CH₄, carbon dioxide—CO₂, etc.). Preferably, such an improved process can still operate at near-ambient temperature and significantly differs from the cryogenic distillation commonly used to separate gases. Selective adsorbent materials can also still be used as trapping material, preferentially adsorbing the target gas species at high pressure.

It is still yet a further object, feature, and/or advantage of the present disclosure to improve upon the process of segregating certain gases (e.g., methane—CH₄) from a gaseous mixture (e.g., air) at near ambient pressure, wherein the process then swings to a vacuum to regenerate the adsorbent material. Notably, the improved process includes the capability to store, either on a vehicle or at biogas upgrading facility, at least two gas species (e.g., methane—CH₄, carbon dioxide—CO₂, etc.). Preferably, the improved system would still be among the most efficient systems measured on customary industry indices, such as recovery (product gas out/product gas in) and productivity (product gas out/mass of sieve material). Additionally, the improved process can utilize a smaller compressor, blower, or other compressed gas or vacuum source and lower power consumption.

The low-pressure storage and separation of biogas in adsorbed gas systems in vehicles disclosed herein can be used in a wide variety of applications. For example, the benefits they provide can be used to enhance the effectiveness of dual-mode separation/storage systems that function on demand both as fuel storage/delivery systems and as gas separators. Such dual-mode separation/storage systems can include those shown and described by the present inventors in Newport et al., “Analysis of Dual, Onboard Storage and Separation of Biogas in Carbon-Based Adsorbed Gas Systems”, Ind. Eng. Chem. Res. 2024, 63, 20304-20314, which is hereby incorporated by reference in its entirety herein. These dual-mode separation/storage systems permit direct use of biogas (a commercially important renewable natural gas) as a fuel to run the vehicle and return separated CO₂ at the gas station, or enrichment of natural gas with renewable H₂ (hydrogen from surplus from surplus electricity) on storage and on board. These carbon-based tanks can consist of highly porous monolithic carbons that can effectively store and separate methane from CO₂ or H₂.

It is preferred the low-pressure storage and separation of biogas in adsorbed gas systems in vehicles disclosed herein be safe to put onto vehicles, cost effective, and durable.

For example, regarding durability, use of low-pressure storage and separation of biogas in adsorbed gas systems described herein can obviate the need to use some other, e.g., liquid or cryogenic, storage/separation systems onboard vehicles. LNG can sometimes outperform ANG in storage density, but is not competitive because of expensive cryogenic equipment to keep CH₄ liquid at −162° C. LNG fueling stations are even more expensive than CNG stations; LNG emits CH₄ by boil off, which makes its GHG footprint higher than CNG.

Additionally, it is also an aim to improve indices which have a more directly measurable difference in the overall system, like the amount of product gas divided by the system weight and size, the system initial and maintenance costs, the system power consumption or other operational costs, and reliability.

Regarding safety, a rich body of technologies exists to separate bulk CH₄ and CO₂ in biogas. They are used in existing RNG plants to upgrade raw biogas to pipeline-grade RNG and include adsorption, membrane separation, biological upgrading, absorption, and cryogenic methods. But of these, only adsorption is a candidate for onboard CH₄—CO₂ separation to be integrated into an ANG tank. The dual function of one and the same tank—storage and separation—is critical to the present disclosure and can be safely implemented. Storage brings molecules together; separation separates them. So, the innovation is that both can be achieved and controlled by one single device, thereby allowing for the significant simplification of parts.

Regarding cost-effectiveness, it should be appreciated that there are a range of target commercial markets for the present technology, each with its own value proposition. These markets include: the U.S. consumer market, the biogas market, the RNG market, the carbon credit market, the ANG market, and the NG vehicle market. The global biogas market was valued at fifty-five billion U.S. dollars in 2019 and is projected to reach one hundred ten billion U.S. dollars y 2025. The U.S. market, currently at eight billion U.S. dollars, is forecasted to grow to ten billion U.S. dollars. This technology incentivizes additional growth of municipal and agricultural biogas in the U.S., which make for 60% of the total, by ⅓. The remarkable fact that in 2019, 39% of all on-road NG fuel used in the U.S. was RNG is the result of a remarkable growth of RNG for transportation, in part fueled by subsidies, carbon credits, and other incentives. If all 108 RNG plants currently under construction or development with an average capital investment cost of $33M per plant, 60% of which are for gas cleanup/upgrade and pipeline injection—were constructed and operated as low-grade RNG plants (no gas cleanup, no pipeline injection), this will save the industry significant money in one-time capital investment costs and over one billion U.S. dollars per year in recurring operating costs. Under California's carbon credit of $120 per metric ton of CO₂ equivalent, the 7.5M tons of CO₂ equivalent displaced by RNG over the last 5 years created a value of $900M, or $180M/year. The present technology adds additional value of $400M/year created by distributed CH₄—CO₂ separation under this proposal ($200M from CH₄, $200M from sequestered CO₂). ANG vehicle demonstration partnerships with corporate partners allow for the building of vehicle platforms that incorporate low-pressure refueling systems, at a total of approximately $12,500 per truck. NG powers over 175,000 NG vehicles in the U.S. and about 23M worldwide. Large-scale NG vehicle operators in the U.S. include large fleets of vehicles for shipping and numerous local operators ranging from city and school buses to airport shuttles. Bringing RNG/RH2 to areas without NG infrastructure will serve existing NG vehicle operators and create new ones.

Methods can be practiced which facilitate use, manufacture, assembly, maintenance, and repair of low-pressure storage and separation of biogas in adsorbed gas systems which accomplish some or all of the previously stated objectives.

The low-pressure storage and separation of biogas in adsorbed gas systems can be incorporated into other systems, such as agricultural vehicles, which accomplish some or all of the previously stated objectives.

According to some aspects of the present disclosure, a method to separate methane from biogas in a single step and store the methane at a reduced pressure comprises: pressurizing a mobile, vehicular tank that includes utilizing a porous adsorbent with biogas to 50-70 bar, wherein the porous adsorbent has a gravimetric methane storage capacity of at least 0.13 kg methane/kg adsorbent and a volumetric storage capacity of at least 0.08 kg methane/liter tank at a temperature of about 20° C. and a pressure of about 60 bar, releasing/discharging gas at an exit pressure between 60 bar (full tank) and 5 bar (near-empty tank) into a destination vessel, releasing gas that has a concentration of methane at least 10% greater than the first introduced biogas, into the destination vessel by rapid depressurization of the tank at an external temperature of about 20° C., where the tank is for tractor-trailer transportation of biogas and the destination vessel is a stationary methane storage tank at a biogas processing facility, and extracting, when the pressure in the tank has dropped to about 25 bar, gas that has a carbon dioxide concentration of at least 80%, where extraction is accomplished by applying a vacuum at the exit port and the destination vessel is a carbon dioxide storage tank at the biogas processing facility.

According to some aspects of the present disclosure, a method to deliver biogas to a natural gas engine and capture carbon dioxide at a reduced pressure comprises: pressurizing a mobile, vehicular tank that includes utilizing a porous adsorbent with biogas to 50-70 bar, wherein the porous adsorbent has a gravimetric methane storage capacity of at least 0.13 kg methane/kg adsorbent and a volumetric storage capacity of at least 0.08 kg methane/liter tank at a temperature of about 20° C. and a pressure of about 60 bar, releasing/discharging gas at an exit pressure between 60 bar (full tank) and 5 bar (near-empty tank) into a destination vessel, releasing gas that has a concentration of carbon dioxide at least 20% greater than the first introduced biogas, into the destination vessel by slow depressurization of the tank at an external temperature of about 20° C., where the tank is for fueling of a natural gas vehicle and the destination vessel is the fuel injection system of the vehicle; and extracting, when the pressure in the tank has dropped to about 25 bar, gas that has a carbon dioxide concentration of about 60%, where extraction is accomplished by applying a vacuum at the exit port and the destination vessel is a carbon dioxide storage tank at a carbon dioxide processing facility. If the tank system includes a secondar adsorbent-filled tank and a compressor, the carbon dioxide concentration can be raised to at least 99%.

According to some aspects of the present disclosure, a biogas storage and delivery system (“tank”), mobile on a vehicle, comprises: (a) one or more storage vessels filled with a porous adsorbent; (b) pressure valves, pressure regulators, pressure/temperature transducers at inlet, outlet, and intermediate ports; and (c) an onboard compressor/gas extraction pump. The biogas storage and delivery system (“tank”) can separate biogas into methane and carbon dioxide such that, consecutively: (a) a concentration of methane in discharged gas is at least 10% greater than in biogas (purified methane); and (b) a gas extracted upon evacuation is at least 80% carbon dioxide (purified carbon dioxide).

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows separation of benzene and air by pore engineering (left) and TSA (right). In this case, benzene, nitrogen, and oxygen competed for the same surface sites because benzene was present at a very low concentration.

FIG. 2A shows CO₂ and greenhouse gas emissions in heavy-duty NG vehicles relative to diesel, with storage as compressed natural gas (CNG), liquefied natural gas (LNG), and renewable compressed natural gas (RNG). Emissions are well-to-wheel.

FIG. 2B shows power-to-gas in California.

FIG. 3A shows a map of the NG grid map of the U.S. and evidences that the grid is concentrated where fossil NG is produced, and mostly non-existent where RNG is produced.

FIG. 3B shows estimated biomethane generation potential.

FIG. 4 shows a one-tank configuration for separating methane from biogas in a single step and store the methane at a reduced pressure. FIG. 4 can also be characterized as a schematic of a vehicular adsorbed natural gas (ANG) tank and its use to upgrade biogas to methane-rich fuel or commodity at discharge of the tank.

FIG. 5 shows a two-tank configuration for delivering biogas to a natural gas engine and capture carbon dioxide at a reduced pressure.

FIG. 6 shows an example of store variable-grade RNG and RH2 in vehicles on a low-pressure adsorbed natural gas (ANG) tank.

FIG. 7 illustrates increasingly efficient packing of adsorbent in an ANG tank, leading to increasing storage capacity of the tank. On the left, the tank contains no adsorbent and holds low-density gas only. In the center, the tank holds particulate adsorbent (e.g., porous pellets). Close-packing of adsorbent particles leaves about 40% of the internal tank volume as void space, holding non-adsorbed, low-density gas. High-density storage occurs in high-density films in the pores of the adsorbent. On the right, the tank holds a monolith of adsorbent, shaped to leave zero void space in the tank (perfect adsorbent packing).

FIGS. 8A-8C show carbon monoliths of various origins. For example, FIG. 8A shows Nuchar® (Ingevity: North Charleston, SC); FIG. 8B shows cylindrical monolith Br-318 (University of Missouri, Rash et al. (2017)); and FIG. 8C shows monoliths to fit into cylindrical vessels (Adsorbed Natural Gas Products, U.S. Pat. No. 10,113,696 Bl).

FIG. 9 illustrates co-adsorption of CH₄ and CO₂ in a vessel filled with porous carbon adsorbent and the release of CH₄-enriched gas upon desorption (CH₄ concentration up to 89%) in repeated fill/empty cycles.

FIG. 10A shows storage of a one-component gas, here CH₄, by adsorption, consisting of a high-density adsorbed film and low-density non-adsorbed gas, in a tank with sorbent packing fraction f=1 (perfect packing, monoliths), f=0.63 (close-packed powder), and f=0 (compressed gas only) at constant gas pressure p. For CH₄ on carbon at 23° C., the film density is 0.30 g/cm³ at 35 bar (near-liquid CH₄).

FIG. 10B demonstrates Gₑₓ is the quantity measured in the lab is independent of packing and porosity, and carries the high-density film.

FIG. 10C when a two-component gas is adsorbed (G_{abs, 1(ρn)}: i=1, CH₄; G_{abs, 2(ρn)}: i=2, CO₂), one component, here CO₃, is preferentially adsorbed and retained while the other, CH₄, is depleted as the pressure is lowered from ρ₁ to ρₙ (discharge of the tank).

FIG. 11 shows hypothetical storage densities for a CH₄—CO₂ mixture as a function of gas pressure p and mass fraction x_{gas,CH4} of CH₄ in the gas phase, representative of CO₂ being more strongly adsorbed than CH₄, as shown in FIG. 10C.

FIG. 12 shows that in a tank filled with carbon monoliths Br-318 and pressurized with 60% CH₄ and 40% CO₂, slow discharge, starting at 60 bar, produces a gas output rich in CO₂ (triangles, amount of CO₂ stored in tank) and poor in CH₄ (pentagons, amount of CH₄ stored in tank) as the pressure drops. Discharged amounts of CO₂ and CH₄ as the pressure drops from 60 bar to 45 bar are indicated by arrows. The result is that the output concentration of CO₂ increases by about 20% over the fill concentration of 40%, as the pressure drops from 60 bar to 25 bar. At a tan pressure of 25 bar, when gas extraction by evacuation begins, the CO₂ concentration is about 60%.

FIG. 13 shows that in a tank filled with carbon monoliths Nuchar® and pressurized with 60% CH₄ and 40% CO₂, slow discharge, starting at 60 bar, produces a gas output rich in CO₂ (triangles, amount of CO₂ stored in tank) and poor in CH₄ (pentagons, amount of CH₄ stored in tank) as the pressure drops. Discharged amounts of CO₂ and CH₄ as the pressure drops from 60 bar to 45 bar are indicated by arrows. The result is that the output concentration of CO₂ increases by about 20% over the fill concentration of 40%, as the pressure drops from 60 bar to 25 bar. At a tan pressure of 25 bar, when gas extraction by evacuation begins, the CO₂ concentration is about 60%.

FIG. 14 shows that a tank filled with carbon monoliths Br-318 and pressurized with 60% CH₄ and 40% CO₂, rapid discharge, accompanied by a large temperature drop inside the tank, starting at 60 bar, produces a gas output with CH₄ concentration increasing by 10%, from 55% to 65%, as the pressure in the tank drops from 60 bar to 25 bar. At a tan pressure of 25 bar, when gas extraction by evacuation begins, the CH₄ content of the tank has dropped to about 20% and the CO₂ content has risen to about 80% (integration of concentrations in FIG. 14).

FIG. 15 shows that in a tank filled with carbon monoliths Nuchar® and pressurized with 60% CH₄ and 40% CO₂, rapid discharge, accompanied by a large temperature drop inside the tank, starting at 60 bar, produces a gas output with CH₄ concentration between 70% and 75%, at least 10% greater than the fill concentration of 60%, as the pressure in the tank drops from 60 bar to 25 bar. At a tan pressure of 25 bar, when gas extraction by evacuation begins, the CH₄ content of the tank has dropped to about 20% and the CO₂ content has risen to about 80% (integration of concentrations in FIG. 15).

FIG. 16 shows CH₄ and CO₂ storage densities under fast, non-equilibrium discharge (depressurization, from left to right) from a vessel holding Br-318 with 40% void fraction in the vessel.

FIG. 17 shows CH₄ and CO₂ storage densities under fast, non-equilibrium discharge (depressurization, from left to right) from a vessel holding Nuchar® carbon with 40% void fraction in the vessel.

FIG. 18 shows CH₄ concentrations of gas released under fast, non-equilibrium discharge (depressurization) from a vessel holding Br-318 with a void fraction of 10%, 20%, and 40%.

FIG. 19 shows CO₂ concentrations of gas released under fast, non-equilibrium discharge (depressurization) from a vessel holding Br-318 with a void fraction of 10%, 20%, and 40%.

FIG. 20 shows adsorption isotherms for CH₄ in a 10 Å graphene pore and computed storage densities (3D equilibrium isotherms) of CH₄ co-adsorbed on a graphene model for Br-318, as a function of pressure in the tank and CH₄ concentration in the gas phase in equilibrium with the adsorbed phase. FIG. 20 also shows that in a tank filled with carbon monoliths Br-318 and pressurized with 60% CH₄ and 40% CO₂, slow discharge, starting at 60 bar, produces a gas output poor in CH₄ as the pressure drops.

FIG. 21 shows adsorption isotherms for CO₂ in a 10 Å graphene pore and computed storage densities (3D equilibrium isotherms) of CO₂ co-adsorbed on a graphene model for Br-318, as a function of pressure in the tank and CH₄ concentration in the gas phase in equilibrium with the adsorbed phase. FIG. 21 shows that in a tank filled with carbon monoliths Br-318 and pressurized with 60% CH₄ and 40% CO₂, slow discharge, starting at 60 bar, produces a gas output rich in CO₂ as the pressure drops.

FIG. 22 shows adsorption contours for CH₄ and CO₂ in a 10 Å graphene pore.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

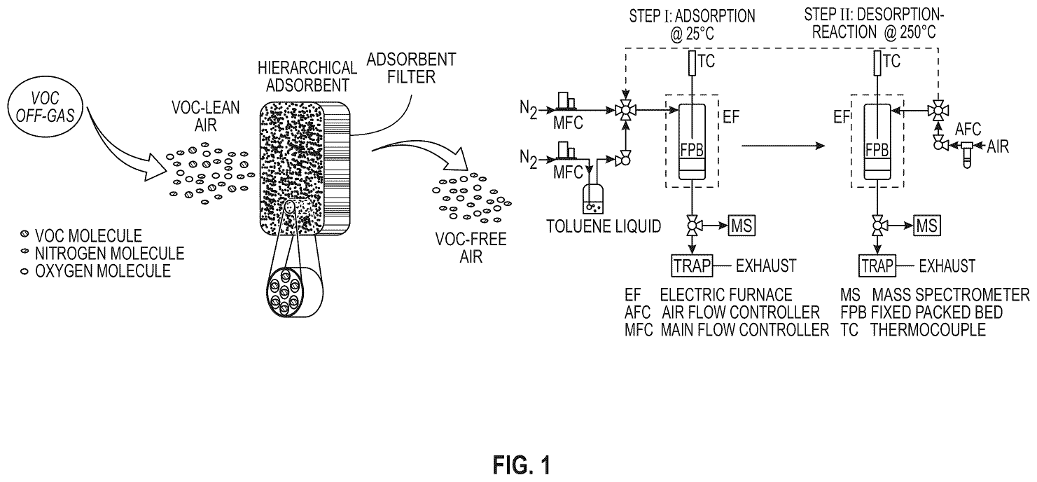

Different chemical species in a gas, which on the surface of an unstructured adsorbent or catalyst compete for the same surface sites and therefore are hard to separate by selective adsorption, can be separated with high yield and superior kinetics (mass transfer) by targeted engineering of pore structures and targeted application of temperature-swing adsorption (dynamic adsorption). Benzene and air that are shown separated in this way in FIG. 1. Toluene has also been oxidized by air in a single adsorption/reaction step by targeted temperature control. The underlying principles of controlled vs. uncontrolled pore structure and pressure/temperature-swing adsorption for gas separation, including CO₂ separation, have previously been demonstrated by the present inventors.

These results and this technology can be quite beneficial when considered with the technologies described herein, because high-performance adsorbents for an automotive natural gas storage tank are intrinsically structured porous solids. Both microporous materials and other materials that host a hierarchy of micro- and mesopores exhibit superior separation properties. Both materials host selective mass sinks, here for one or the other component of CH₄—CO₂ and CH₄—H₂ mixtures. One or the other gas component, or both, can be coerced into programmed desorption, by appropriate temperature- and pressure-swing adsorption/desorption, so as to separate CO₂ from CH₄ on demand, or generate on demand a mixed-gas flow optimized for optimum engine performance.

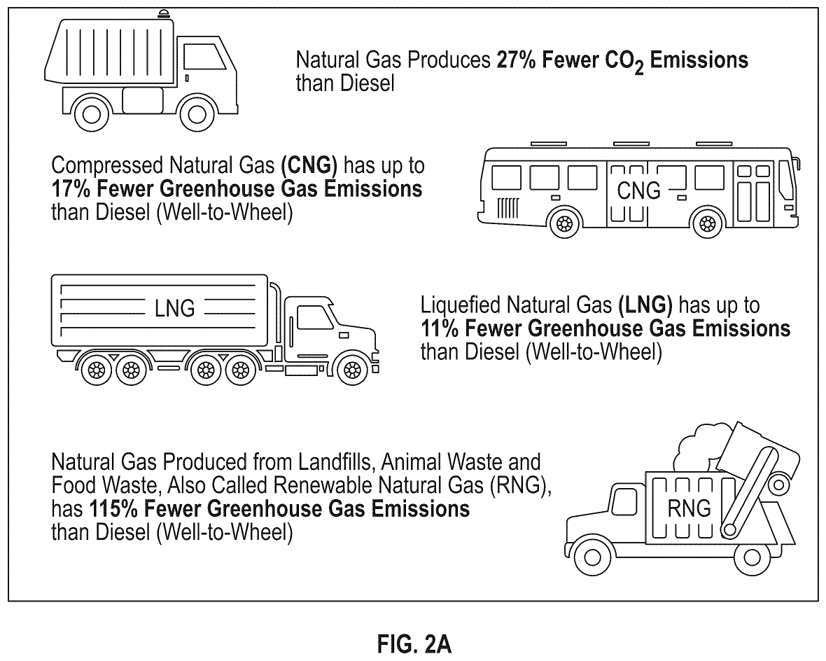

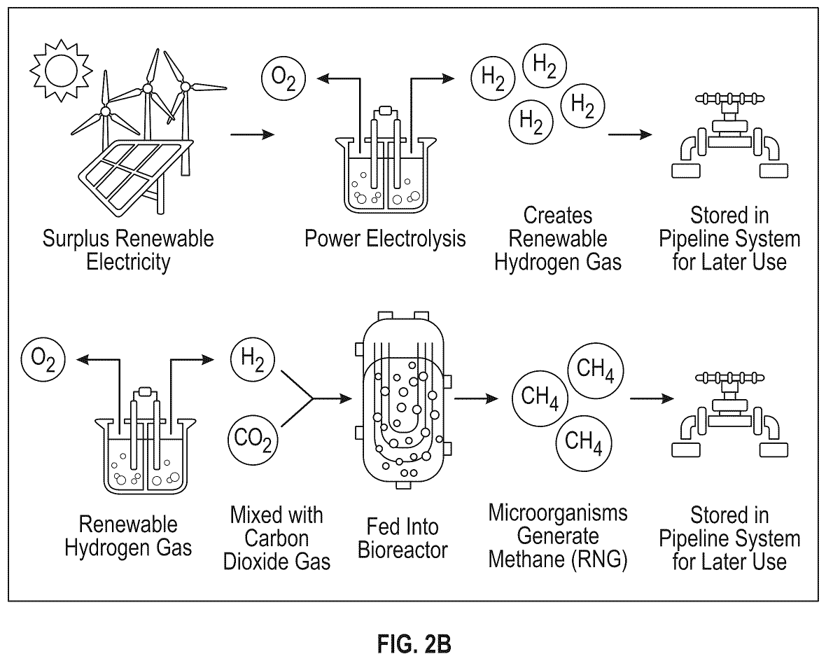

As climate change and the development of sustainable energy resources challenge the world, there is a burden to find renewable substitutes of liquid fuels for growing power demands. Methane, the primary constituent of natural gas (NG), produces significantly lower greenhouse gas emissions than any other hydrocarbon. If it is produced renewably (RNG, also referred to as biomethane or, if not purified, as biogas), it is even a net carbon sink (FIG. 2A). RNG comes from landfills, livestock operations, sewage plants, agricultural anaerobic digesters. A second source of renewable methane is synthetic methane using hydrogen produced by electrolysis of water with solar or wind electricity. The combination of the two processes converts all carbon in biomass into methane:

$$2 {( {CH}_{2} O )}_{n} ( carbohydrates ) \to n ( {CH}_{4} + {CO}_{2} ) [ biomethane ]$$

$${CO}_{2} + 4 {H}_{2} ( solar , wind ) \to {n CH}_{4} + 2 {H}_{2} O [ synthetic methane ]$$

The first step is anaerobic digestion of carbohydrates, resulting in about 60% CH₄ and 40% CO₂. The second step, with hydrogen produced from intermittent surplus electricity and using the CO₂ from anaerobic digestion, is commonly referred to as “power-to-gas” (Sabatier reaction or, alternatively, biomethanation). The two processes offer a uniquely sustainable program for decarbonization and storage of renewable energy in NG pipelines. If biomethane is produced from dairy, capturing otherwise released methane from livestock, it is the showcase for carbon-negative fuels with a Carbon Intensity (CI) index of −280 (g CO₂eq/MJ). In comparison, diesel fuel has a CI index of +100.

FIG. 2A shows CO₂ and greenhouse gas emissions in heavy-duty NG vehicles relative to diesel, with storage as compressed natural gas (CNG), liquefied natural gas (LNG), and renewable compressed natural gas (RNG). Emissions are well-to-wheel. FIG. 2B shows power-to-gas in California. The top row shows production of renewable H₂ from surplus electricity and storage, mixed with NG, in the NG pipeline system. The bottom row shows the conversion of H₂ and CO₂ in a bioreactor into CH₄. The pilot plant, installed by SoCalGas and the National Renewable Energy Laboratory, is the nation's first biomethanation reactor system. Overall, RNG reached 39% of all on-road NG fuel used in the U.S. in 2019.

The two processes are pursued aggressively in Germany, other European countries, and also in the U.S. (FIG. 2B), but plants that combine these processes exist mostly at the demonstration level, and not at wide production levels. One reason is that Sabatier reactors are costly, while biomethanation as an industrial process is still years away (FIG. 2B). Even production and distribution of pipeline-grade RNG from biogas, the second process, faces barriers.

For example, there is abundant biogas production in municipal and agricultural areas in the U.S. But only few plants process the biogas to pipeline-grade RNG. Of the ten suppliers of RNG listed by SoCalGas in California, only two have started pipeline injection as of June 2020. The reason is that cleaning of biogas to pipeline standards, including separation of CO₂, is expensive for smaller operators. Smaller operators offer low-grade RNG (partly cleaned biogas, ˜50 vol % CH₄, ˜50 vol % CO₂), suitable for heating, electricity production, and internal combustion engines. The City of Columbia, MO, which burns its landfill gas in an electric power plant, is a municipal example.

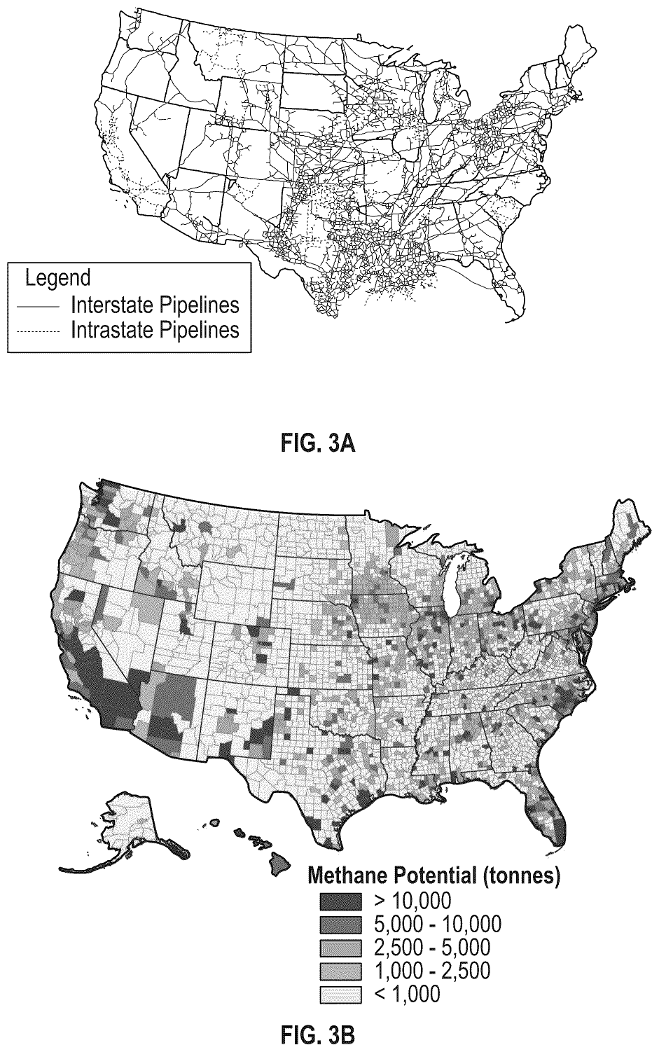

The reason the U.S. does not produce local, low-grade RNG is because conventional NG vehicles run on CNG, and compression of NG to CNG fueling station pressure, 250 bar, is too expensive for small biogas operators, which can cost two million U.S. dollars per station or more. The production of pipeline-grade RNG is not attractive if a region is not served by a nearby pipeline. Pipeline costs are approximately one million U.S. dollars per mile. Large parts of the U.S. where RNG is or could be produced, are not served by interstate or intrastate pipelines, as shown in FIG. 3A.

In the absence of CO₂ from biogas for methanation, the second process outline above, or of a methanation plant, renewable H₂ (RH2) is mixed with NG and injected into the NG pipeline grid (FIG. 2B). The resulting enrichment of NG with H₂ (up to 25 vol % H₂), offers the consumer a high-value fuel (octane values of CH₄ and H₂ are 120 and >130, respectively), but again depends on NG pipelines near RH2 plants.

The present disclosure develops, demonstrates, and brings to the marketplace a technology that removes all of these barriers, to large-scale production, distribution, and use of stranded RNG and RH2.

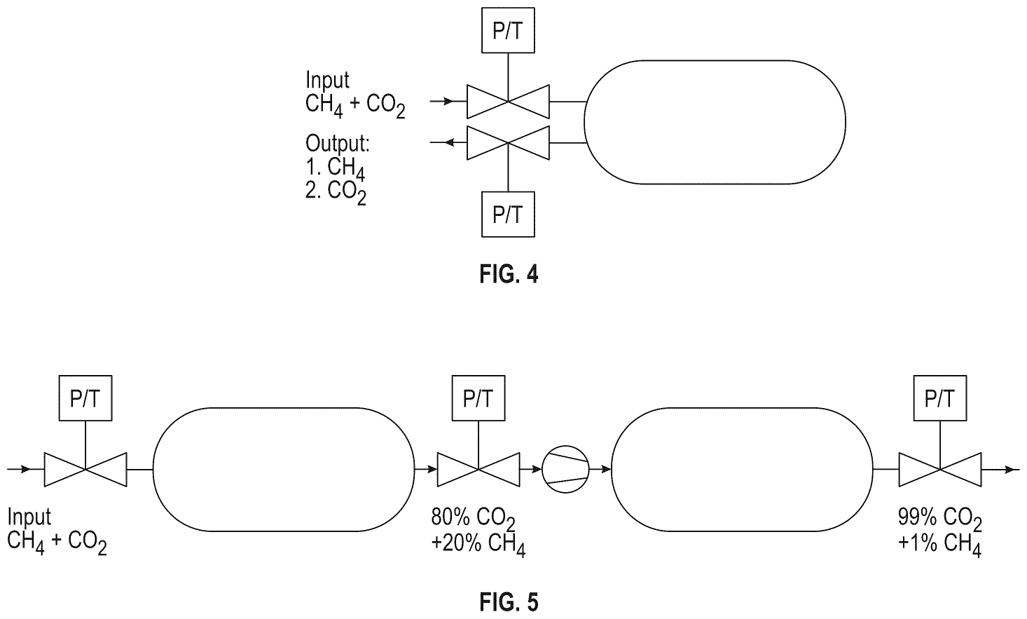

For example, FIG. 4 shows a one-tank configuration for separating methane from biogas in a single step and store the methane at a reduced pressure. Biogas, a mixture of CH₄ and CO₂, is injected or continuously pumped by pressurization into the tank packed with adsorbent. Under depressurization of the tank, monitored by pressure/temperature transducers (P/T), the desorbed, discharged gas first is rich in CH₄ and poor in CO₂, and later rich in CO₂ and poor in CH₄. Only when the tank is near-empty, does the CO₂ concentration in the output gas increase. Inlet and outlet ports are drawn as separate for clarity; however, it is to be appreciated that in some embodiments, filling and emptying of the tank may proceed through the same port.

The new use of vehicular ANG tanks in the present disclosure is storage and delivery of biogas, coupled with upgrade of biogas to a methane-rich commodity. The upgrade occurs onboard at delivery, where delivery may be delivery of fuel to the engine of an NGV, or delivery of biogas to a biogas processing plant if the tank is part of a virtual pipeline. Biogas is a mixture of about 60 vol % methane (CH₄) and about 40 vol % carbon dioxide (CO₂). Therefore, value propositions of a high CH₄ content in the output at delivery are, in the engine case, improved caloric value of the fuel for driving; and, in the virtual-pipeline case, a no-cost first purification step in the upgrading process of biogas to 90 vol % CH₄ or better (pipeline-grade natural gas, biomethane, renewable natural gas, RNG) at the processing plant. Delivery of CH₄-rich gas to an engine or a biogas processing plant, in this disclosure, is also referred to as separation, CH₄/CO₂ separation, separation of CH₄ from CO₂, or purification of CH₄.

In a second example, FIG. 5 shows a two-tank configuration for delivering biogas to a natural gas engine and capture carbon dioxide at a reduced pressure. As shown in FIG. 5, output of the first tank, rich in CO₂ and poor in CH₄, is re-pressurized by a compressor and injected into the second tank. The second adsorption/desorption cycle generates nearly pure CO₂. For a tank operating pressure (full tank) of 60-70 bar, only a single-stage compressor is needed to fill the second tank.

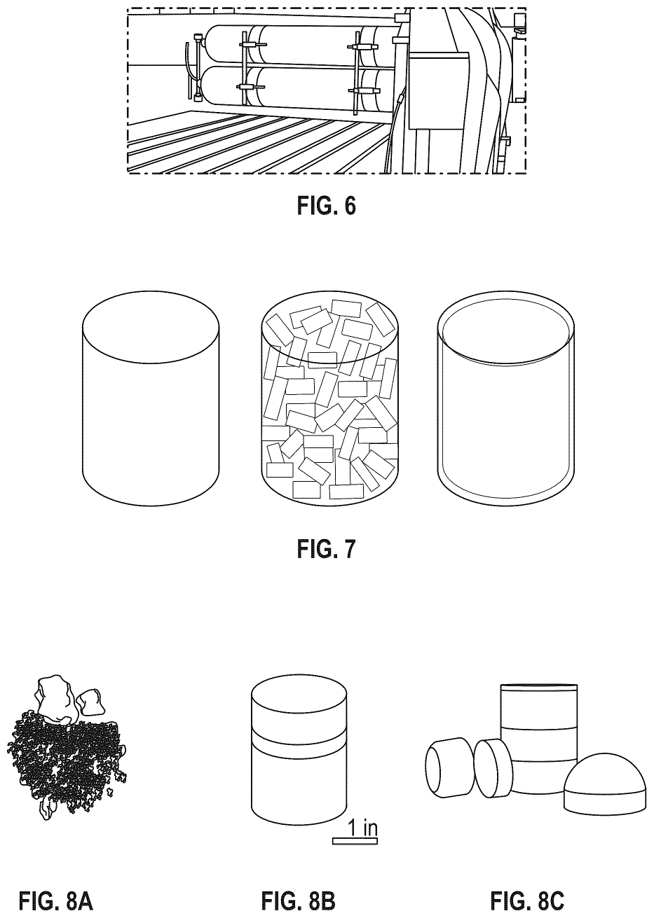

The aforementioned examples can be implemented by way of store variable-grade RNG and RH2 in vehicles on a low-pressure adsorbed natural gas (ANG) tank, as shown in FIG. 6. These tanks can be arranged in parallel, in series, or a mixture thereof. The tanks utilize adsorbent, but are not limited to using any one particular adsorbent. For example, the adsorbent can be a monolithic carbon with distinct pore architectures and different fuel discharge characteristics. Operation and performance of the tanks for CH₄ can be described with respect to H₂. The tanks achieve an extended driving range over CNG by low-pressure regulation.

Low-pressure ANG storage platforms, like those presented in FIG. 6, can incorporate low-pressure refueling systems. The tanks solve the high-pressure problem by enabling the customer to fuel at approximately 60 bar (e.g. between 50 and 70 bar) instead of 250 bar. Compression of NG to 60 bar requires only a two-stage instead of four-stage compressor and costs much less in terms of equipment and only ¼ in terms of energy of operation. Despite the low pressure, the ANG tank outperforms a CNG tank not only in compression costs and fueling convenience, but competitively also in tank weight, volume, and driving range (FIG. 6). Example storage amounts in the tanks can comprise: a 40-liter tank, holding 21 kg of carbon monoliths, which stores 4.2 kg CH₄ at 35 bar, 3.9 kg of which adsorbed as a monomolecular, near-liquid-CH₄-density film, on 47 km² of surface area.

The tanks solve the CO₂ separation problem by configuring an ANG tank as switchable from an onboard fuel delivery system to an onboard gas separation system. The dual functionality will enable the vehicle operator to choose, on demand, between running a NG engine on inexpensive low-grade RNG, or running the engine on high/pipeline-grade RNG and return unused fuel as CO₂-rich commodity to the local fueling station or processing plant. Returning CO₂ will be an attractive business for both the vehicle and plant operator (carbon credit, sequestration, raw material for methanation or other use of CO₂). For a vehicle operator running the engine on low-grade RNG (CH₄—CO₂ mixture), the ANG tank system will, by design, deliver a mixed-gas flow optimized for optimum engine performance.

The tanks solve the unattractive production of pipeline-grade RNG and the dependence on NG pipelines near RH2 plants by making biogas and RH2 plant operators independent of NG pipelines by relying on local production and use of variable-grade RNG and RH2, by virtue of distributed fuel processing (onboard CH₄—CO₂ separation) or by low-pressure multi-fuel infrastructure (delivery of CH4—CO2—H2 mixtures to engine), will enable municipal and agricultural communities to become circular economies with self-sufficient RNG/RH2 microgrids.

The tanks enable current/future biogas producers to bring biogas and derivatives to market without NG pipelines and CNG fueling infrastructure, and work similarly for RH2 producers. Derivatives are low/high-grade RNG and sequestered CO₂. High-grade RNG and sequestered CO₂ can be generated by consumers (distributed, onboard separation of CH₄ and CO₂). Local production and use for transportation of such CH₄/CO₂/H₂ creates new wealth for participating communities.

FIG. 7 illustrates increasingly efficient packing of adsorbent in an ANG tank, leading to increasing storage capacity of the tank. On the left, the tank contains no adsorbent and holds low-density gas only. In the center, the tank holds particulate adsorbent (e.g., porous pellets). Close-packing of adsorbent particles leaves about 40% of the internal tank volume as void space, holding non-adsorbed, low-density gas. High-density storage occurs in high-density films in the pores of the adsorbent. On the right, the tank holds a monolith of adsorbent, shaped to leave zero void space in the tank (perfect adsorbent packing).

FIGS. 8A-8C show carbon monoliths of various origins. For example, FIG. 8A shows Nuchar® from Ingevity; FIG. 8B shows cylindrical monolith Br-318 (University of Missouri, Rash et al. (2017)); and FIG. 8C shows monoliths to fit into cylindrical vessels (Adsorbed Natural Gas Products, U.S. Pat. No. 10,113,696 Bl).

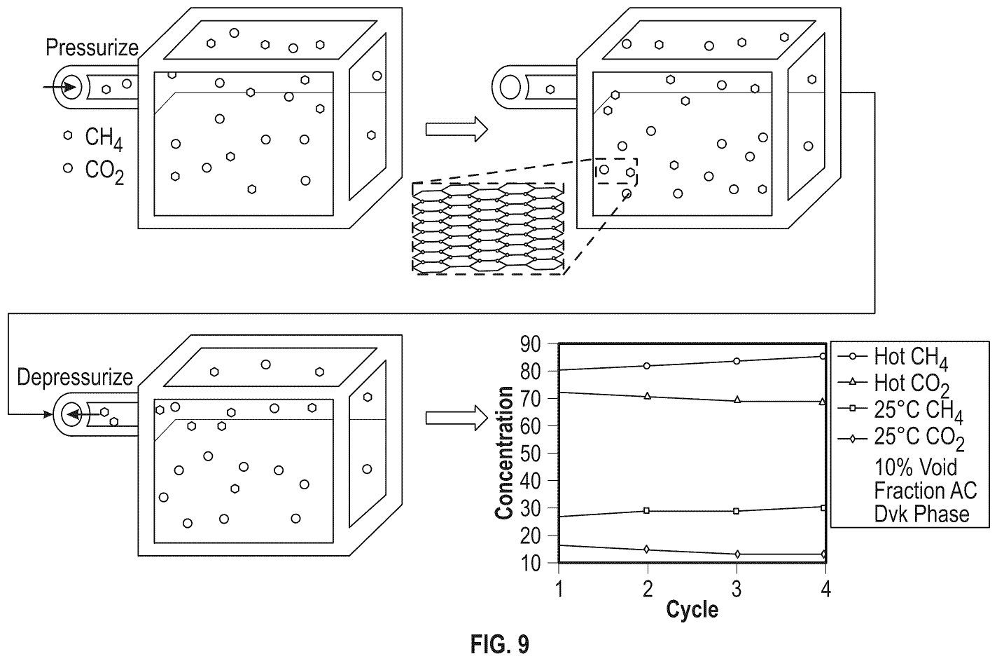

FIG. 9 illustrates co-adsorption of CH₄ and CO₂ in a vessel filled with porous carbon adsorbent and the release of CH₄-enriched gas upon desorption (CH₄ concentration up to 89%) in repeated fill/empty cycles. See Newport et al., supra.

In a typical embodiment of the invention, biogas is injected or continuously pumped by pressurization into a vessel packed with adsorbent, as illustrated in FIGS. 4-5. The vessel packed with adsorbent constitutes the ANG tank. The adsorbent is preferably chosen in the form of close-packed monoliths with negligible void space in the tank, as illustrated in the right side of FIG. 7, so as to achieve high storage capacity and high separation capacity. But other packings, with non-negligible void space as in the center of FIG. 7 or as shown in Figures FIG. 9 are admissible, too. Microporous carbon monoliths investigated for the present disclosure are shown in FIGS. 8A-8C.

In one embodiment, the target pressure for the tank to be filled to capacity (“full tank”) with biogas (“feed gas”) is chosen to be 60 bar, and the target temperature inside the tank is chosen to be 25° C. (approximately room temperature). Pressure and temperature will rise during pressurization, will fall during depressurization, and are monitored by sensors indicated in FIGS. 4-5. When pressure and temperature in the full tank, with all valves closed, have reached their target values and equilibrated (equilibrium between the high-density film of co-adsorbed CH₄ and CO₂, and the low-density non-adsorbed gas, FIG. 9), the gas phase in the tank has a composition different from that of the feed gas: The gas in the tank is CH₄-enriched and CO₂-depleted relative to the feed gas because the adsorbent has a higher affinity for CO₂ than for CH₄. Preferential adsorption of CO₂ depletes the gas phase of CO₂ and enriches it with CH₄. Consequently, the very first, very small quantity of gas released from the full tank will always be CH₄-enriched.

However, it is not obvious that subsequent small (or not small) quantities of gas discharged from the tank will continue to be CH₄-enriched. The present disclosure demonstrates, for appropriately chosen adsorbents, that CH₄-enrichment relative to the feed gas can be achieved over a wide range of pressures from 60 bar down; over a range of initial tank temperatures; over a range of feed gas compositions; over a range of adsorbent packings; and over a range of discharge modes (isothermal/slow, non-isothermal/fast). Metrics for CH₄ enrichment and separation will be: (i) CH₄ and CO₂ concentrations in the output gas, (ii) absolute amount of CH₄ and CO₂ discharged, and (iii) amount of CH₄ and CO₂ discharged per unit pressure drop as the tank is depressurized.

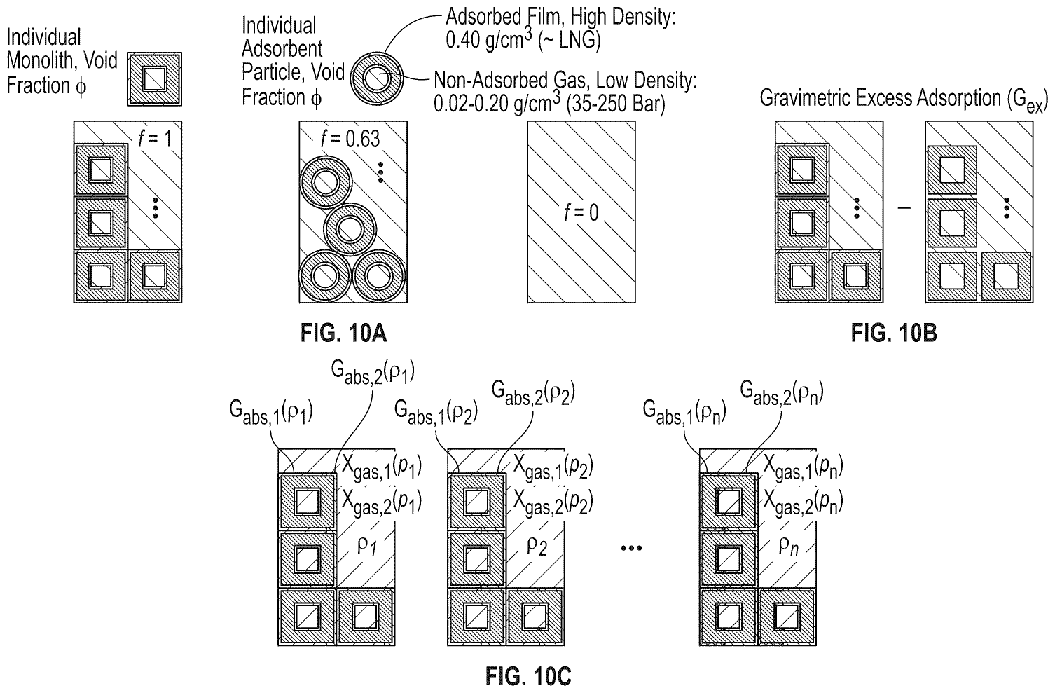

FIG. 10A shows storage of a one-component gas, here CH₄, by adsorption, consisting of a high-density adsorbed film and low-density non-adsorbed gas, in a tank with sorbent packing fraction f=1 (perfect packing, monoliths), f=0.63 (close-packed powder), and f=0 (compressed gas only) at constant gas pressure p. For CH₄ on carbon at 23° C., the film density is 0.30 g/cm³ at 35 bar (near-liquid CH₄). For CH₄ on carbon at 23° C., the film density is 0.30 g/cm³ at 35 bar (near-liquid CH₄). Storage density (mass of adsorbed and non-adsorbed CH₄ per volume of tank) is ρ=f·[Gₑₓ·(1−φ)ρₛₖₑₗ+φρ_{gas}]+(1−f)·ρ_{gas}, where Gₑₓ is gravimetric excess adsorption (mass of excess CH₄ per mass of sorbent); φ, ρₛₖₑₗ are porosity and skeletal density of the sorbent; and ρgas is the density of non-adsorbed gas. FIG. 10B demonstrates Gₑₓ is the quantity measured in the lab is independent of packing and porosity, and carries the high-density film. Gₑₓ≠Σ·t_{film}·(ρ_{film}−ρ_{gas}), with specific surface area of sorbent Σ=2600 m²/g; film thickness t_{film}=0.40-0.41 nm (monolayer); film density ρ_{film}˜ρ_{gas}·exp(E_{b}/(RT)) at low p and ˜0.39-0.42 g/cm³ at high p (saturation); and E_{b}=average binding energy=16 kJ/mol (all data is for CH₄ on MU monolith BR-0311). Thus, ρ at fixed p is large if f=1 (monoliths), φ is low (nano/microporous adsorbent), Σ is large (high surface area), and E_{b} is large (high binding energy). FIG. 10C when a two-component gas is adsorbed (G_{abs, 1}(ρₙ): i=1, CH₄; G_{abs, 2}(ρₙ): i=2, CO₂), one component, here CO₃, is preferentially adsorbed and retained while the other, CH₄, is depleted as the pressure is lowered from ρ₁ to ρₙ (discharge of the tank). A natural metric to monitor the change is gravimetric adsorption of component i, G_{ads,i} (mass of adsorbed i per mass of sorbent), and the mass fraction x_{gas,i} of i in the gas phase, in equilibrium with the adsorbed phase. For unequally adsorbed components, the mass fraction of adsorbed i, x_{ads,i}=G_{ads,i}/(G_{ads,1}+G_{ads,2}), is different from the mass fraction of i in the gas phase, x_{ads,i}≠x_{gas,i}. For preferential adsorption of component 2, x_{ads,1}<x_{gas,1} and x_{ads,2}>x_{gas,1}. The adsorbent separation capacity, or selectivity, of component 2 over component 1 is quantified by the ratio S_{2/1}=(G_{ads,2}/x_{gas,2})/(G_{ads,1}/x_{gas,1}).

The challenge is to transform a frontrunner for commercially attractive adsorbents for ANG, about which much is known in terms of structure, mechanisms, and control of performance for pure CH₄ (FIG. 10A, 10B), into a controllable storage, delivery, and separation system for multicomponent gases (FIG. 10C). No such work, akin to taking a semiconductor with a known band gap to an efficient photovoltaic system, has been done.

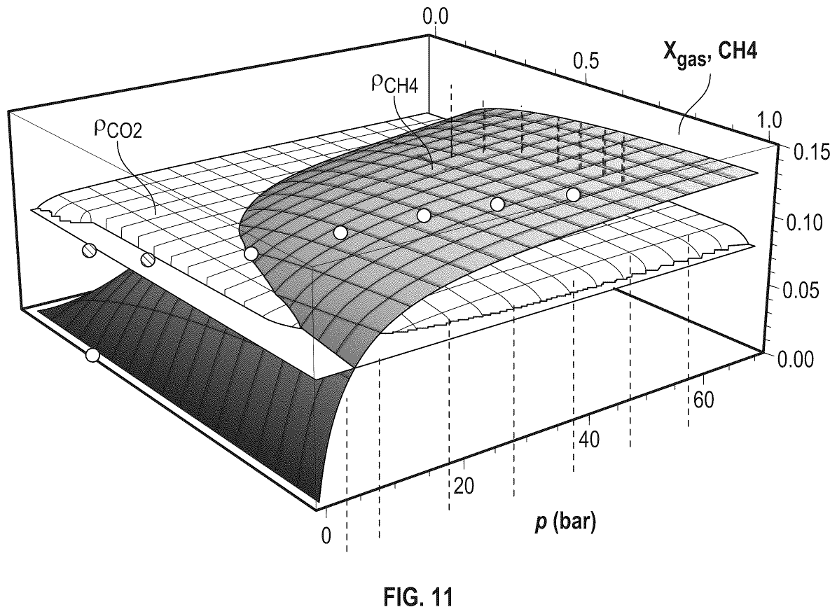

For pure CH₄ at constant temperature, the all-important storage density at pressure p (also called volumetric storage capacity), which counts both adsorbed and non-adsorbed CH₄, is a function of a single variable, ρ(p), from which the amount of fuel delivered as the pressure in the tank is lowered from full to empty can be read off as ρ(p_{full})−ρ(p_{empty}) from a single isotherm, illustrated further below For two components, i=1 (CH₄) and i=2 (CO₂), we need two storage densities ρᵢ(p, x_{gas}), both of which are functions of two variables, pressure p and composition x_{gas} of the gas phase (chosen as mass fraction of CH₄ and denoted by x_{gas,1} or x_{gas,CH4} in FIGS. 10A-10C, 11). No such 3D isotherms, neither experimental nor computational, are yet known for ANG adsorbents. Thus, it was an early objective to construct and analyze pairs of 3D equilibrium isotherms as in FIG. 11 for CH₄—CO₂ and CH₄—H₂ mixtures on best-in-class ANG adsorbents. The analysis will yield storage, delivery, and separation metrics as follows.

FIG. 11 shows hypothetical storage densities for a CH₄—CO₂ mixture as a function of gas pressure p and mass fraction x_{gas,CH4} of CH₄ in the gas phase, representative of CO₂ being more strongly adsorbed than CH₄, as shown in FIG. 10C. The densities are calculated from ρ i=G_{ads,i}·(1−φ)ρₛₖₑₗ+φ·x_{gas,i}ρ_{gas} (i=CH₄, CO₂), x_{gas},CO₂=1−x_{gas,CH4}, and a two-component Langmuir model for G_{ads,i}, in the limit of low ρ_{gas} and/or porosity φ. The curves at constant xgas,CH4 are isoconcentration isotherms, such as for x_{gas,CH4}=1. The curves at constant p are isobars along which storage densities vary by variation of gas composition. Starting from a full tank at p=60 bar and xgas,CH₄=0.65, the CH₄ storage density and concentration in the gas phase drop (open dots, FIG. 11), while the CO₂ storage density stays essentially constant (hatched dots, FIG. 11, most of which are hidden under the ρ_{CH4} surface), as the pressure is lowered for fuel delivery. As the tank is discharged, it delivers gas rich in CH₄ (open dots) and poor in CO₂ (hatched dots) down to 10 bar; below 10 bar, it holds nearly pure CO₂.

The path along the ρ_{CH4} and ρ_{CO2} surface in FIG. 11 as the pressure is lowered from p₁ (full tank) to pₙ (empty tank) during discharge of the tank. The mass fractions xₖ of CH₄ in the gas phase at pressures pₖ are given by

$${x}_{k} - {x}_{k - 1} = {( 1 + \frac{{ρ}_{CO 2} ( {p}_{k} , {x}_{k} ) - {ρ}_{CO 2} ( {p}_{k + 1} , {x}_{k + 1} )}{{ρ}_{CH 4} ( {p}_{k} , {x}_{k} ) - {ρ}_{CH 4} ( {p}_{k + 1} , {x}_{k + 1} )} )}^{- 1}$$

(desorption mass balance; solve the equation above for xₖ₊₁ at given xₖ, pₖ, pₖ₊₁ for k=1, . . . , n). Evaluation of ρ_{CH4} and ρ_{CO2} at (pₖ, xₖ) yields the red and blue data points in FIGS. 10A-10C; predicts that storage of CH₄ decreases initially along a near-isoconcentration line (delivery of CH₄ with near-constant, high x_{gas,CH4}) and finally along a near-isobar (delivery of CH₄ with rapidly diminishing x_{gas,CH4}); predicts that CO₂ storage drops little over a wide range of pressures (nearly flat ρCO₂ surface in FIG. 11), overtakes CH₄ storage where the two surfaces intersect, and remains high even at the lowest pressure (tank holds nearly pure CO₂; successful separation of CO₂ from CH₄).

The pointwise metrics for fuel composition; transition from fuel delivery to fuel separation; and separation capacity (selectivity S_{CO2/CH4} in evaluated with storage densities), during discharge are, for CH₄ fraction in gas at pressure pₖ:xₖ; for the transition from delivery to separation: ρ_{CH4}(pₖ,xₖ)=ρ_{CO2}(pₖ,xₖ); and for CO₂/CH₄ separation capacity at pₖ:

$$\frac{{ρ}_{CO 2} / {x}_{g as , CO 2}}{{ρ}_{CH 4} / {x}_{g a s , CH 4}} = \frac{{ρ}_{CO 2} ( {p}_{k} , {x}_{k} ) \cdot {x}_{k}}{{ρ}_{CH 4} ( {p}_{k} , {x}_{k} ) - ( 1 - {x}_{k} )}$$

The cumulative metrics for fuel delivery, quality, and separation are: for total CH₄ (fuel) delivered to engine: Δ_{CH4}=ρ_{CH4}(p₁, x₁)−ρ_{CH4}(pₙ, xₙ); for the total CO₂ (non-fuel) delivered to engine: Δ_{CO2}=ρ_{CO2}(p₁, x₁)−ρ_{CO2}(pn, xₙ); for the average CH₄ fraction in gas delivered: Δ_{CH4}/(Δ_{CH4}+Δ_{CO2}); for the total residue in empty tank: ρ_{CH4}(pₙ, xₙ)+ρ_{CO2}(pₙ, xₙ); and for the average CO₂/CH₄ separation capacity: Δ_{CO2}/Δ_{CH4}.

Estimates of binding energies E_{b} for CH₄ and CO₂ come from Henry's law, FIG. 10A, or enthalpies of adsorption. Binding energies and enthalpies of adsorption are help model and control the thermal response and desorption kinetics during discharge of the tank, which in turn help identify discharge protocols for separation of CH₄ and CO₂ and to establish controllability of storage, delivery, and separation.

A full catalogue of coadsorption data for CH₄, H₂, where fuel delivery at near-constant composition is the engineering goal (no separation of CH₄, H₂), can generate with a computer surfaces similar to FIG. 11. For example, the ρ_{CH4} and ρ_{H2} surfaces will look different from FIG. 11. The H₂ surface lies above the CH₄ surface at high p and x_{gas,CH4} (CH₄ is adsorbed more strongly than H₂), and neither of the two are as flat as the CO₂ surface of FIG. 11.

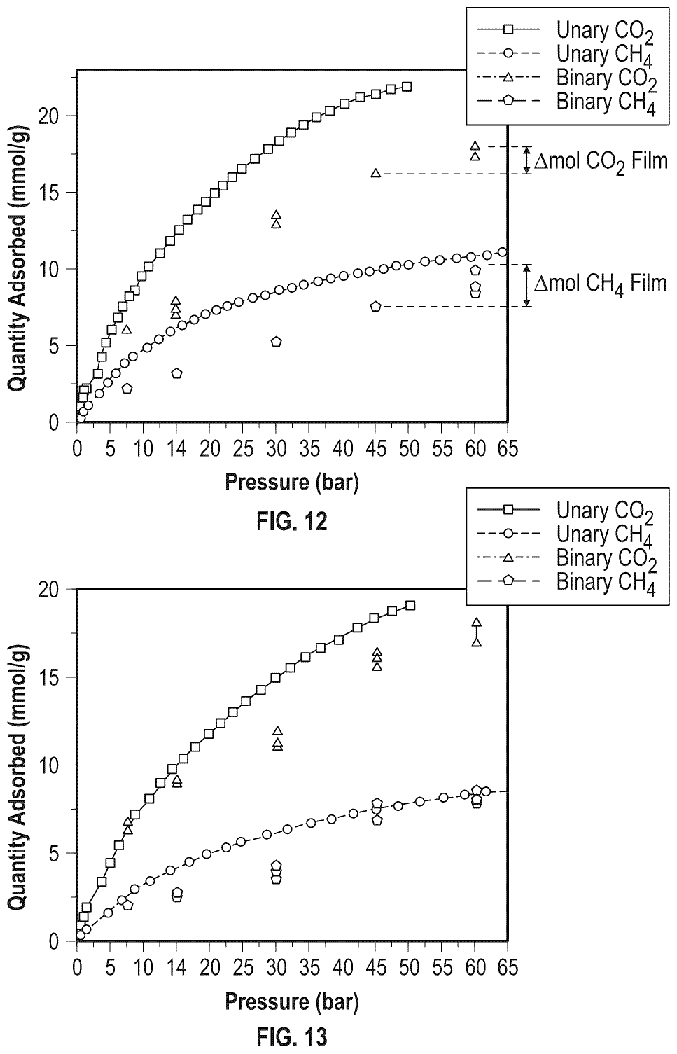

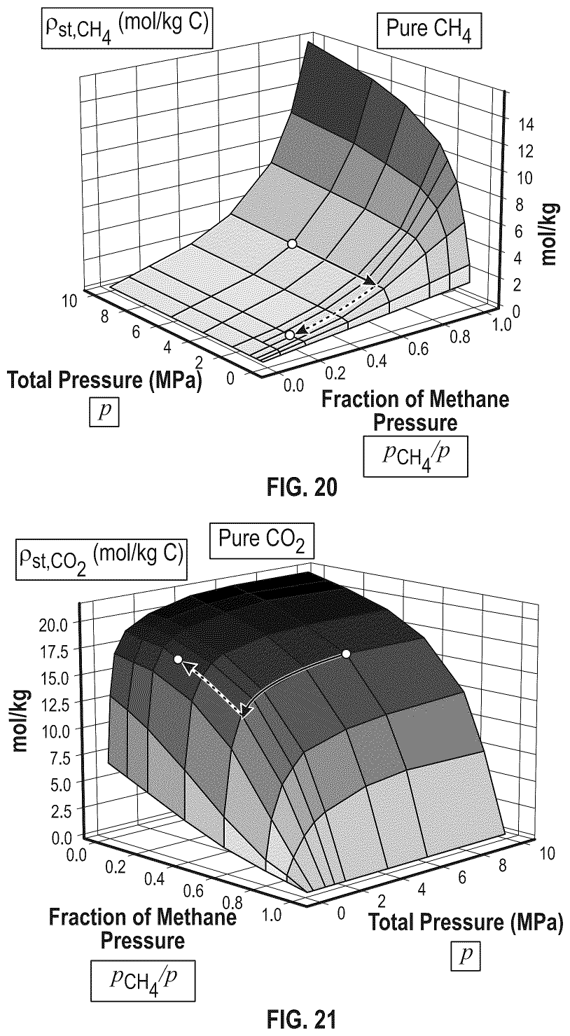

FIGS. 12-13 show equilibrium adsorption isotherms (i.e., storage densities) for co-adsorption of CH₄ (pentagons) and CO₂ (triangles) from breakthrough experiments with a 50/50 vol % CH₄/CO₂ feed gas mixture on Br-318 (FIG. 12) and Nuchar® carbon (FIG. 13). Differences in storage density at decreasing pressure give amounts of CH₄ and CO₂ discharged slowly, as in FIGS. 20-21. Also shown in FIGS. 12-13 are adsorption isotherms for pure CH₄ (red) and pure CO₂ (black). High values of CO₂ storage density, relative to CH₄ density, show preferential adsorption of CO₂ in all cases. The data in FIGS. 12-13 correspond to a tank with zero void fraction.

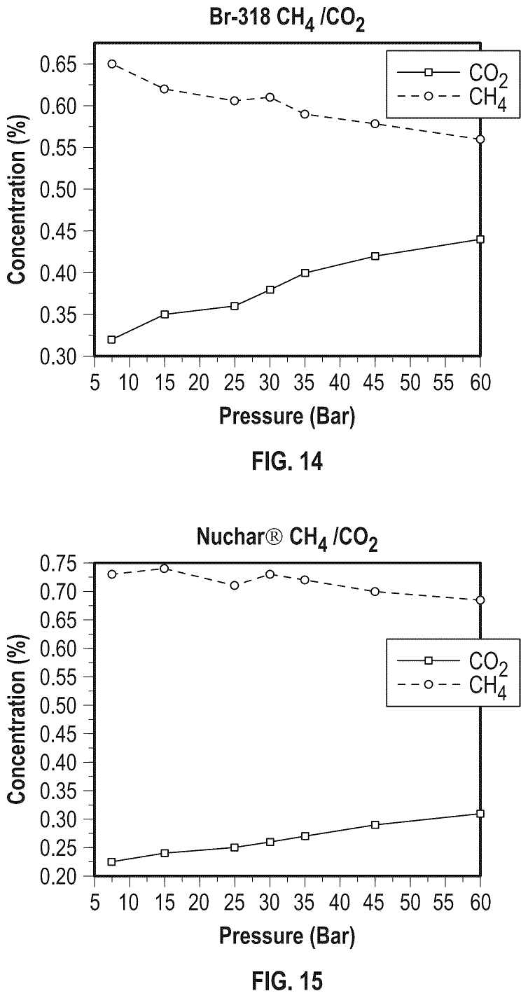

FIGS. 14-15 show CH₄ and CO₂ concentrations of gas released under fast, non-equilibrium discharge (depressurization, from right to left) from a vessel holding Br-318 (FIG. 14) and Nuchar® carbon (FIG. 15) with a void fraction of 40% (Newport et al. (2024)). The vessel was initially pressurized with 50/50 vol % CH₄/CO₂ feed gas at 60 bar, and gas was sampled for off-line composition analysis at pressures dropped from 60 bar down to 7.5 bar. The CH₄ concentration at 60 bar (full tank; 58 vo % for Br-318, 68 vol % for Nuchar®), is higher than in the feed gas (50 vol %) because preferential adsorption of CO₂ depletes the gas phase of CO₂.

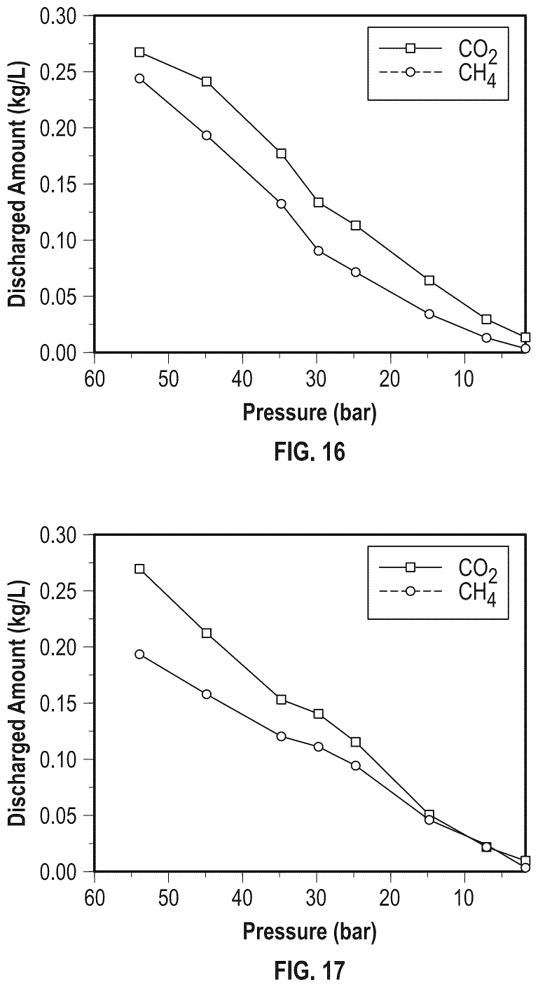

FIGS. 16-17 show CH₄ and CO₂ storage densities under fast, non-equilibrium discharge (depressurization, from left to right) from a vessel holding Br-318 (FIG. 16) and Nuchar® carbon (FIG. 17) with 40% void fraction in the vessel (Newport et al. (2024)). Unlike in the case of slow discharge where storage densities decrease nonlinearly with decreasing pressure (FIGS. 12-13, 20-21), storage densities in FIGS. 16-17 decrease nearly linearly with decreasing pressure in the vessel. This is consistent with the fact that the CH₄ and CO₂ concentrations in FIGS. 14-15 increase and decrease, respectively, only modestly as the pressure decreases.

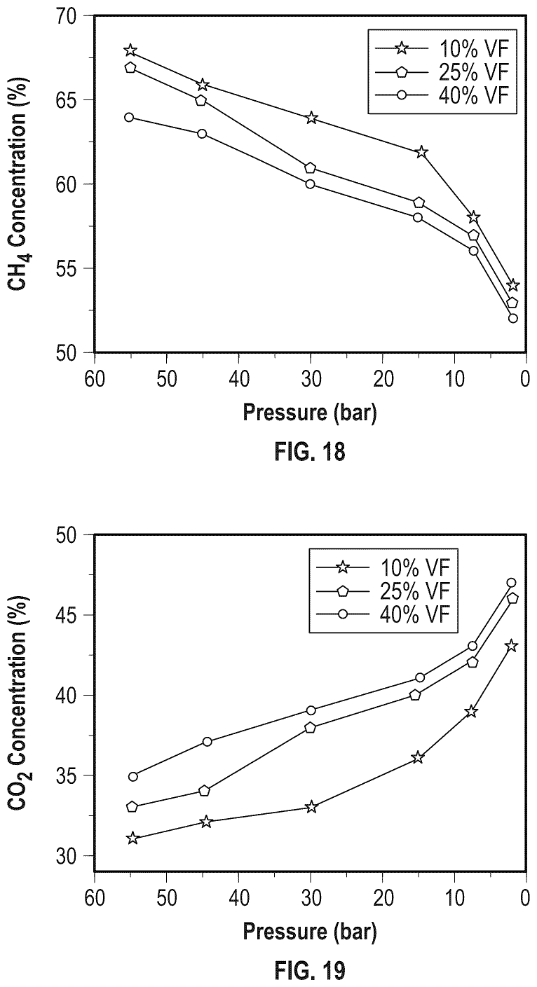

FIGS. 18-19 show CH₄ (FIG. 18) and CO₂ (FIG. 19) concentrations of gas released under fast, non-equilibrium discharge (depressurization) from a vessel holding Br-318 with a void fraction of 10%, 20%, and 40% (Newport et al. (2024)). The vessel was initially pressurized with 50/50 vol % CH₄/CO₂ feed gas at 55 bar, and gas was sampled for off-line composition analysis at pressure dropped from 55 bar to 7.5 bar. Shows, as expected, that decreasing void fraction yields increasingly superior CH₄/CO₂ separation performance. If minimal separation is desired, such as to deliver a fuel stream of approximately constant composition from the tank to the engine in a vehicle, a void fraction of 40% will be fine.

FIGS. 20-21 show computed storage densities (3D equilibrium isotherms) of CH4 and CO2 co-adsorbed on a graphene model for Br-318, as a function of pressure in the tank and CH4 concentration in the gas phase in equilibrium with the adsorbed phase. The concentration corresponds to the concentration in the output gas in FIG. 4 under slow discharge of the tank. High values of CO₂ storage density show preferential adsorption of CO₂. The large dots show initial storage density at 60 bar and 60 vol % CH₄ in the gas phase (full tank) and the resulting final storage density at 10 bar (“near-empty tank”), after the tank has ben slowly depressurized from 60 bar to 10 bar. The concentration in the gas phase drops from 60 to 30 vol % CH₄ during the discharge, but 2 out of 3 molecules discharged are CH₄. Most of the CO₂ (16 out of 17 molecules at 60 bar) remains in the tank at 10 bar. The data in FIGS. 20-21 corresponds to a tank with zero void fraction.

FIGS. 20-21 also show that in a tank filled with carbon monoliths Br-318 and pressurized with 60% CH₄ and 40% CO₂, slow discharge, starting at 60 bar, produces a gas output rich in CO₂ (FIG. 21) and poor in CH₄ (FIG. 20) as the pressure drops. The graphs show simulated storage densities of CH₄ and CO₂ as a function of total pressure in the tank and CH₄ concentration of the output gas in a single tank (first tank in a two-tank configuration). Orange paths show the drop in CH₄ concentration from 60% to 10% and the rise in CO₂ concentration from 40% to 70%, as the pressure drops from 60 bar to 20 bar. When this output of the first tank is re-pressurized to 60 bar and injected into the second tank (FIG. 5). FIG. 21 shows that the output of the second tank at 20 bar, again under slow discharge, has a CO₂ concentration of about 99%.

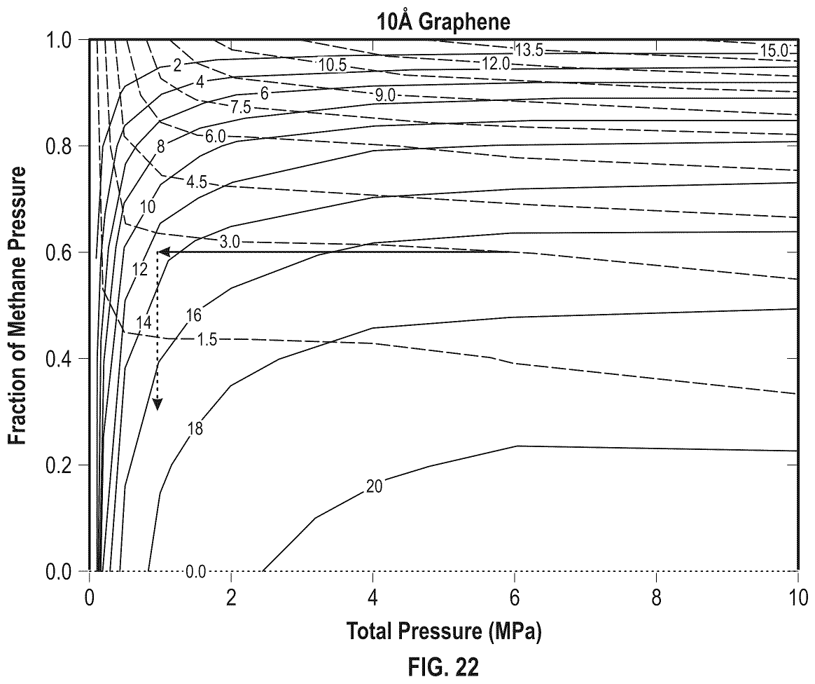

FIG. 22 shows adsorption contours for CH₄ and CO₂ in a 10 Å graphene pore. The solid line and dotted arrows represent a possible pressure swing adsorption cycle. As we go from 60 bar to 45 bar, the CH₄ isotherm drops more quickly than the CO₂ isotherm, so that the CH₄ film releases more gas (CH₄) than what the CO₂ film releases. This demonstrates similarly that CH₄ is enriched in the discharge from 60 bar to 45 bar.

From the foregoing, it can be seen that the present disclosure accomplishes at least all of the stated objectives.

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A method of pressurizing a mobile, vehicular tank comprising of:
utilizing a porous adsorbent with biogas to 50-70 bar;
discharging gas at an exit pressure between 5 bar when the tank is near empty and 60 bar when the tank is near full into a destination vessel;
releasing gas with a concentration of methane (CH₄) greater than the first introduced biogas into the destination vessel by rapid depressurization of the tank; and
when the pressure in the tank has dropped to about 25 bar, extracting the gas that has a carbon dioxide (CO₂) concentration of at least 60%, wherein extraction is accomplished by applying a vacuum at the exit port and the destination vessel is a carbon dioxide storage tank at the biogas processing facility.

2. The method of claim 1, further comprising controlling separation of the CH₄ and the CO₂ by pressure and/or temperature-swing desorption.

3. The method of claim 1, further comprising controlling separation of the CH₄ and the CO₂ by expanding the pore/void space with a movable piston in the tank.

4. The method of claim 1, further comprising controlling separation of the CH₄ and the CO₂ by choosing an adsorbent with a large porosity selected from the group consisting of BR-0311 and activated carbon.

5. The method of claim 1, further comprising controlling separation of the CH₄ and the CO₂ by choosing an adsorbent with lower binding energy for the CH₄ and the CO₂.

6. The method of claim 1, further comprising, enabling a vehicle operator to choose, on demand, between running a NG engine on inexpensive low-grade RNG, or running the engine on high/pipeline-grade RNG and return unused fuel as CO₂-rich commodity.

7. The method of claim 1, further comprising, locally producing and using variable-grade RNG and RH2, by virtue of distributed fuel processing or by low-pressure multi-fuel infrastructure.

8. The method of claim 7, wherein the distributed fuel processing comprises onboard CH₄—CO₂ separation.

9. The method of claim 7, wherein the low-pressure multi-fuel infrastructure comprises delivery of CH₄—CO₂—H₂ mixtures to an engine.

10. The method of claim 9, wherein the engine is on a tractor.

11. A self-sufficient RNG/RH2 microgrid capable of carrying out the method of claim 7.

12. The method of claim 1, wherein the porous adsorbent has a gravimetric methane storage capacity of at least 0.13 kg methane/kg adsorbent.

13. The method of claim 1, wherein the porous adsorbent has a volumetric storage capacity of at least 0.08 kg methane/liter tank at a temperature of about 20° C.

14. The method of claim 1, wherein the gas is released with a concentration of methane at least 10% greater than the first introduced biogas into the destination vessel by rapid depressurization of the tank.

15. The method of claim 13, wherein the gas is released with a concentration of methane at least 20% greater than the first introduced biogas into the destination vessel by rapid depressurization of the tank.

16. The method of claim 1, wherein the tank is for tractor-trailer transportation of biogas and the destination vessel is a stationary methane storage tank at a biogas processing facility.

17. The method of claim 1, wherein the tank is for fueling of a natural gas vehicle and the destination vessel is the fuel injection system of the vehicle.

18. The method of claim 1, wherein extracting the gas occurs when the gas has a carbon dioxide concentration of at least 80%.

19. A single-column, single-cycle, single high-pressure high-capacity, long-residence-time system in which input and output enter and leave through a single port and gas line, the system being capable of carrying out the method of claim 1.

20. The system of claim 19, wherein the system is capable of pressurization and depressurization.
